(19) United States
(12) Patent Application Publication
(10) Pub. No.: US 2004/0260962 A1
(43) Pub. Date: Dec. 23, 2004

(54) Systems and methods for latching data

(76) Inventors: Victor Suen, Fremont, CA (US); William Lau, Foster City, CA (US); Hui-Yin Seto, San Jose, CA (US)

Correspondence Address: LSI LOGIC CORPORATION, 1621 BARBER LANE, MS: D-106 LEGAL, MILPITAS, CA, 95035, US

(21) Appl. No.: 10/601,441

(22) Filed: Jun. 23, 2003

(51) Int. Cl. G06F 1/12

(52) U.S. Cl. 713/401

(57) ABSTRACT

Systems and methods are provided for latching a data signal. In one embodiment, a system comprises a first delay circuit that programmably delays a strobe signal with a first delay to latch a data signal. The system also comprises a second delay circuit that receives the data signal and delays the data signal with a second delay that is substantially inherent to the first delay. The system may include a logic circuit coupled between the first and the second delay circuits for latching the data signal in substantial alignment with the strobe signal. In one embodiment, similar delays are used in a master delay circuit, while in another embodiment such delays are used in slave devices connected to a master delay circuit.

### BACKGROUND OF THE INVENTION

1. Field of the Invention

The invention generally relates to high-performance electronic data signal exchange including, for example, double data rate (DDR) memory components (e.g., DDR Synchronous Dynamic Random Access Memory components, or DDR SDRAMs) and/or other high speed electronic devices. More specifically, the present invention relates to methods and associated structure for providing signal delays to latch data from a high speed memory component to a high speed memory controller.

2. Discussion of Related Art

In high speed electronic data exchange, it is common that a data signal may be latched, or registered, in accord with an associated strobe or clock signal. The strobe or clock signal generally signifies when the data is valid to be so latched. For example, a number of present-day computing systems and other present-day applications utilize high-performance memory subsystems to store and retrieve data. A high-performance computing system stores its programmed instructions and associated data in a high-performance memory subsystem for rapid fetching and execution of the associated program. Numerous memory architectures are known to provide the requisite high levels of performance. Generally, a system stores data in a memory subsystem by issuing write commands from the memory controller to the memory components and retrieves the stored data by issuing read commands from the memory controller to the memory components. Most such high-performance memory subsystems include features to read from (or write to) sequential locations in the memory components in response to a single read (or write) command. In other words, the memory components themselves return data from the sequential locations after being initially directed to a location associated with the read command. In high-performance memory subsystems the memory components may receive a clock signal from the memory controller and the memory components themselves provide a strobe signal used to indicate when valid data is available on an associated data bus as the various sequential locations of a burst read command are made available from the memory component.

Proper strobe signal timing is important to data transfers between electronic devices because the strobe signal, in essence, controls the flow of data between the devices. Strobe signal timing is particularly important in high speed data transfers where signal durations are shorter (i.e., higher frequency and hence shorter signal periods). It is common that a desired or specified timing relationship exists between the strobe signal and the associated data signal. For example, it may be specified in the desired signal exchange that the strobe signal follows (is delayed after) the data signal by some fraction of a clock period (such as ¼ clock cycle or ⅕ clock cycle). Present design solutions for such fractional clock period delays use delay lines—an electronic circuit that delays a signal applied to its input and applies the delayed signal as its output. The amount of the delay may be fixed or programmable.

In one common design approach a master delay circuit determines an appropriate delay amount for the actual circuit die (i.e., in situ) to achieve the specified fraction of a clock period delay. The delay amount so determined is then provided as programming input to programmable delay lines used for delaying strobe or other signals by the required, specified fractional clock period. The programmable delay lines so coupled to the master are often referred to as slave delay lines. A master delay circuit “locks” onto an applied clock signal and helps generate uniform delays for slave delay lines associated with the strobe signals to align the strobe signals with the data signals as specified for the particular application.

The master delay line applies a signal representing the programmed delay to the slave delay lines. Typically the programmed delay is represented as an incremental offset from a base delay of the slave delay line. This base delay may also be referred to herein as an overhead delay, an inherent delay or a minimum delay. A problem arises if the required delay is less than (or too close to) the minimum delay of the programmable slave delay line. As data speeds increase, associated fractional delay times have become shorter because clock periods are shorter. For any particular technology in a circuit design there is an associated minimum delay that may be practically achieved. If the minimum delay is too long to permit generation of the desired fractional clock period delay, a problem arises because the master delay cannot provide the necessary programmed delay to associated slave delay lines to align the strobe signals with the data signals.

In general, the purpose of such a master/slave delay architecture is to provide more accurate slave delay settings. The master delay lock circuit structure determines a desired delay (within the above discussed constraints) that accounts for circuit fabrication variations over the entire circuit die or that accounts for operating condition variations over the entire circuit die. A further problem may arise in that fabrication process or operating variations over portions of the circuit die may impose variations in clock signals generated at one area of the circuit die as compared to other areas of the circuit die. In other words, process or operating condition variations may cause variations in the minimum delay of a first slave delay line in one portion of the circuit die as compared to another slave delay line at another location of the circuit die.

At high frequency signal rates, even these very small overhead delay variations may be sufficient to skew the clock, strobe and data signals relative to the required timing relationships. Such delay variations over different areas of the circuit dies may contribute to further inaccuracies in achieving the specified timing relationships at present high speed signaling standards. These delays, albeit smaller than previous delays and therefore improved by the master/slave architecture, are still particularly significant as data transfer speeds between high speed electronics devices increase. Even sub-nanosecond delays may be sufficient to affect data capture with high speed devices because of the tight tolerance specifications of such interfaces.

Although discussed herein primarily with respect to memory designs, these problems are not specific to memory components as they arise in many high speed electronic applications. Timing precision is necessary in many high speed electronic applications, among other reasons, to ensure that data integrity is maintained during data transfers. As design goals seek to increase data transfer speeds in these high speed electronic applications, timing precision becomes an increasingly important design issue. Accordingly, it is evident that a need exists for improved methods and structures for alignment of clocks and strobes in high speed electronics.

### SUMMARY OF THE INVENTION

The present invention solves the above and other problems, thereby advancing the state of useful arts, by providing methods and associated structures to enable overhead delay compensation and to attain previously unattainable delays from a master delay control circuit and as applied to programmable slave delay line circuits that affect the alignment of strobe and data signals. More specifically, another delay circuit, having substantially the same inherent delay and process variations as the programmable delay circuits used in master or slave delay circuits is implemented to impose an overhead delay on associated signals that substantially corresponds to the inherent overhead delay on the programmable delay signal path. The other delay circuit therefore allows the overhead or minimum delay of the programmable delay line to be subtracted out or compensated for. This, in turn, allows for still smaller programmed delays generated by a master delay circuit and applied to a slave delay circuit. In addition, since the overhead compensation delay is fabricated and operating in close proximity to the programmable delay signal path, the process and operating condition induced variations in the two delay signal paths will be essentially identical and therefore, in effect, cancel each other.

In the case of a memory control slave delay circuit application hereof, the other delay (overhead compensation) essentially delays the data signal inasmuch as the overhead delay portion of the slave delay circuit applied to the strobe signal. Since the overhead compensation thus applied to the data path essentially cancels the overhead or minimum delay period of the strobe path, the desired delay programmed into the strobe signal path delay is effectively achieved. The minimum delay is in effect removed from the programmable delay line applied to the corresponding strobe signal. In addition, the two signal paths will have essentially identical process and operating condition variations in their respective delays since the two delay lines will more likely be fabricated in nearly adjacent portions of the circuit die. This effectively helps assure that the programmed delay applied from the master delay circuit to the slave delay circuit will be accurately reproduced at the slave. In like manner, the overhead compensation may be applied to the circuit structure of the master delay circuit to provide similar benefits in elimination of the minimum or overhead delay inherent in the late and early clock signal paths of the master delay lock circuit structures.

In one exemplary embodiment of the invention, a system comprises: a first delay circuit configured for programmably delaying a strobe signal with a first delay to latch a data signal; and a second delay circuit configured for delaying the data signal with a second delay that is substantially inherent to the first delay circuit.

In another exemplary embodiment of the invention, the system further comprises a logic circuit communicatively coupled between the first and the second delay circuits and configured for latching the data signal in substantial alignment with the strobe signal.

In another exemplary embodiment of the invention, the logic circuit comprises a flip/flop device.

In another exemplary embodiment of the invention, the system further comprises a master delay circuit configured for locking a clock signal and for programming the first delay circuit with the first delay therefrom.

In another exemplary embodiment of the invention, the second delay comprises a duration that is less than a cycle duration of the clock signal.

In another exemplary embodiment of the invention, the system further comprises a plurality of the first and the second delay circuits.

In another exemplary embodiment of the invention, the first and the second delay circuits comprise substantially the same integrated circuitry such that the first delay circuit comprises a first overhead substantially having the second delay and the second delay circuit comprises a second overhead having the second delay.

In one exemplary embodiment of the invention, a method provides for latching a data signal, comprising steps of: programmably delaying a strobe signal with a first delay; delaying the data signal with a second delay that is inherently produced by the step of programmably delaying; and registering the data signal responsive to the first delay using the strobe signal.

In another exemplary embodiment of the invention, the method further comprises a step of locking a clock signal to generate a control signal that programmably delays the strobe signal with the first delay.

In another exemplary embodiment of the invention, the step of locking comprises a step of simultaneously transferring the control signal through a plurality of control lines to uniformly perform the step of programmably delaying.

In another exemplary embodiment of the invention, the step of delaying the data signal comprises a step of generating the second delay such that a duration of the second delay is less than a cycle duration of the clock signal.

In another exemplary embodiment of the invention, the step of registering the data signal comprises steps of: receiving the data signal; and latching the data signal with the strobe signal.

In one exemplary embodiment of the invention, a system for latching a data signal, comprises: means for programmably delaying a strobe signal with a first delay; means for delaying the data signal with a second delay that is inherently produced by the means for programmably delaying; and means for registering the data signal responsive to the first delay using the strobe signal.

In another exemplary embodiment of the invention, the system further comprises means for locking a clock signal to generate a control signal that programmably delays the strobe signal with the first delay.

In another exemplary embodiment of the invention, the means for locking comprises means for simultaneously transferring the control signal through a plurality of control lines to uniformly perform the means for programmably delaying.

In another exemplary embodiment of the invention, the means for delaying the data signal comprises means for generating the second delay such that a duration of the second delay is less than a cycle duration of the clock signal.

In another exemplary embodiment of the invention, the means for registering the data signal comprises: means for receiving the data signal; and means for latching the data signal with the strobe signal.

In one exemplary embodiment of the invention, a system comprises a first delay circuit configured for programmably delaying a first signal with a first delay to provide a delayed first signal; and a second delay circuit configured for delaying the first signal with a second delay that is substantially inherent to the first delay circuit to latch the delayed first signal

In another exemplary embodiment of the invention, the system further comprises monitor logic communicatively coupled between the first and the second delay circuits and configured for latching the delayed first signal in substantial alignment with the first signal.

In another exemplary embodiment of the invention, the monitor logic is further adapted to provide timing for the system that corresponds with the first signal and to program the first delay circuit with the first delay therefrom.

In another exemplary embodiment of the invention, the second delay comprises a duration that is less than a cycle duration of the first signal.

In another exemplary embodiment of the invention, the system further comprises a plurality of the first and the second delay circuits.

In another exemplary embodiment of the invention, the first and the second delay circuits comprise substantially the same integrated circuitry such that the first delay circuit comprises a first overhead delay substantially having the second delay and the second delay circuit comprises a second overhead delay having the second delay.

### BRIEF DESCRIPTION OF THE DRAWINGS

FIG. 1 illustrates a prior art system for latching a data signal.

FIG. 2 illustrates a block diagram of a system in an exemplary embodiment of the invention.

FIG. 3 illustrates a flowchart of steps performed by a system for latching data in one exemplary embodiment of the invention.

FIG. 4 illustrates a block diagram of a master delay in an exemplary embodiment of the invention.

### DETAILED DESCRIPTION OF THE DRAWINGS

While the invention is susceptible to various modifications and alternative forms, a specific embodiment thereof has been shown by way of example in the drawings and will herein be described in detail. It should be understood, however, that it is not intended to limit the invention to the particular form disclosed, but on the contrary, the invention is to cover all modifications, equivalents and alternatives falling within the spirit and scope of the invention as defined by the appended claims.

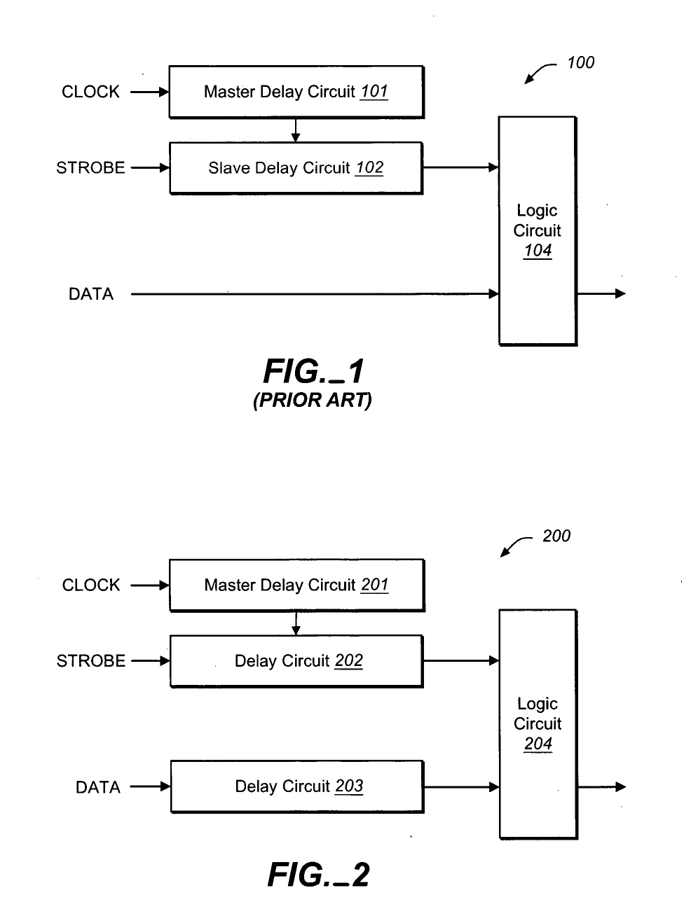

FIG. 1 is a block diagram of a typical system 100 for delaying a strobe signal as is known in the art. System 100 includes master delay circuit 101, slave delay circuit 102 and logic circuit 104. Master delay circuit 101 that corresponds with a clock signal CLOCK by locking onto the clock signal with a delay locked loop is configured to provide timing for other connected circuitry, such as slave delay circuit 102. This delay locked loop is integrated with the circuitry of master delay circuit 101 to adjust timing variations of the clock signal CLOCK which are attributable in part to variations in operating conditions of the circuit such as temperature variations and voltage fluctuations and/or attributable to process variations in forming the associated circuit die. Once master delay circuit 101 locks onto the clock signal CLOCK, the delay circuit 101 generates a control signal which dictates desired delay durations uniformly used by one or more slave delay circuits, such as slave delay circuit 102 delaying a strobe signal STROBE in accordance with the delay of master delay circuit 101.

A slave delay circuit 102 receives the strobe signal STROBE from a high speed electronics device, such as a high speed memory (e.g., a DDR SDRAM) and delays the signal according to the delay indicated by the control signal of master delay circuit 101. The slave delay circuit thereby transfers the strobe signal STROBE to logic circuit 104 to latch an incoming data signal DATA to a receiving device (not shown). An example of logic circuit 104 may include a flip/flop, such as a D flip/flop.

As discussed above, data corruption may occur if the strobe signal STROBE is not aligned as required with the data signal DATA as required. While master delay circuit 101 addresses the timing problems associated with the strobe signals of the slave delay circuits, a timing problem still exists in high frequency applications if the slave delay 102 is incapable of being programmed to the required short duration (i.e., a fraction of the high speed clock period). Such a limitation may arise where the minimum or overhead delay inherent in such delay lines is too large to permit the delay line circuit to be programmed to the desired fractional delay period. If the slave device is incapable of generating the required fraction of a clock period delay, the master/slave design may fail to provide the required delay. Similarly the master delay circuit may be incapable of determining the required fraction of a clock period delay because it uses similar or identical delay components. Such errors may render it impossible to generate the requisite fraction of a clock period delay using such a master/slave design. Other design approaches to provide the requisite fraction of a clock period delay are known to be less accurate and therefore may also lead to data corruption due to inaccurate alignment of DATA and STROBE signals.

Still further, as discussed above, another problem of inaccuracy may arise because the slave delay circuits introduce a variable delay associated with process or operating conditions variations of an overhead in the delay circuit. Though such inaccuracies may be small and principally accounted for by the master delay programming, at very high speeds, even such small variations may cause data corruption problems. Since both the data signal DATA and the strobe signal STROBE typically generate from the same device, the overhead delay misaligns the strobe signal from the data signal. Thus, due to even small inaccuracies in the strobe/data timing, logic circuit 104 may inaccurately latch the data signal DATA and may thereby cause data corruption.

FIG. 2 shows a block diagram of a system for capturing a data signal DATA in one exemplary embodiment of the invention in system 200. In this embodiment, system 200 comprises master delay circuit 201, first delay circuit 202, second delay circuit 203 and logic circuit 204. Delay circuit 202 is configured for programmably delaying a strobe signal STROBE with a first delay to latch the data signal DATA at logic circuit 204. Delay circuit 203 is configured for receiving the data signal DATA and for delaying the signal with a second delay that is substantially inherent to the first delay circuit. In other words, the DATA signal path is delayed by a period substantially equal to the overhead delay inherent in the first delay circuit 202 used on the STROBE signal path. As such, delay circuit 203 may substantially align the data signal DATA with the strobe signal STROBE because delay circuit 203 may comprise a similar overhead delay. Logic circuit 204 may register the data signal consistent with the period of the strobe signal STROBE. Such a registering of data may occur between high speed electronic devices, such as DDR SDRAMs and memory controllers.

To further illustrate, master delay circuit 201 may generate a control signal that indicates a delay (e.g., the programmable delay) to delay circuit 202 to delay the strobe signal STROBE. The strobe signal STROBE may, however, be additionally delayed by a fixed duration that is associated with overhead of delay circuit 202. This overhead delay may comprise a duration that is less than a clock period and may be inherently attributable to circuitry that constitutes delay circuit 202. Thus, when delay circuit 202 programmably delays the strobe signal STROBE, it incrementally delays from the pre-existing overhead delay inherent to circuit 202.

The overhead delay attributed to the delay circuit 202 may be reproduced in delay circuit 203 by using substantially the same circuitry that constitutes delay circuit 202. For example, as delay circuit 202 is configured for programmably delaying the strobe signal STROBE, a similar circuit having no such programmable incremental delay would essentially establish an overhead delay found in delay circuit 202. Accordingly, delay circuit 203 may employ circuitry found in delay circuit 202 to establish a similar overhead delay and thus align the data and the strobe signals.

Additionally, delay circuits 202 and 203 may comprise integrated circuitry such that design implementations of the two circuits are substantially similar. For example, delay circuit 202 and 203 may each be implemented in an integrated circuit die using substantially similar processing techniques. Such an implementation may minimize differences in overhead delay due to fabrication process or environmental variances. Accordingly, implementing delay circuits 202 and 203 using substantially the same processing techniques may result in producing substantially the same overhead delays, thereby aligning the data signal DATA with the strobe signal STROBE. After overhead compensating the data signal DATA, logic circuit 204, communicatively coupled to delay circuits 202 and 203, registers the data signal using the strobe signal STROBE. Registering this overhead compensated data signal DATA may improve accuracy of data transfer because the strobe and data signals are substantially aligned according to the specified relationship of the signal exchange.

While FIG. 2 illustrates one exemplary embodiment, other embodiments may delay data and/or strobe signals in similar fashion that fall within the scope of the invention. Additionally, master delay circuit 201 and logic circuit 204 may be substantially similar in design to other circuits described herein (e.g., master delay circuit 101 and logic circuit 104, both of FIG. 1). However, it should be noted that other design implementations may provide similar functionality for system 200 that also fall within the scope of the invention. Moreover, the inventive concepts described in the embodiment of system 200 are not intended to be limited to the number of delay circuits shown in FIG. 2. Rather, system 200 may employ a plurality of delay circuits 202 and 203 for delaying strobe and data signals.

It will be recognized that the overhead delay (the inherent delay) of the delay circuit 202 applied to the STROBE signal may be compensated by the overhead delay circuit 203 applied to the DATA signal path. Where a different range of desired delays may be required, the compensation overhead delay of delay circuit 203 may be substantially equal to the overhead delay of delay circuit 202 or may be greater than or less than the overhead delay of delay circuit 202. In other words, the compensation delay applied to the DATA signal path may fully compensate for the overhead delay of the STROBE signal path, or may over-compensate or under-compensate for the minimum delay on applied to the STROBE signal. In all such cases, the overhead delay applied to the STROBE signal path is compensated to varying desired degrees by the overhead compensation delay circuit applied to the DATA signal path. Still further, such timing relationships and associated overhead compensation may be applied to any related signals to achieve a desired timing relationship. DATA and an associated STROBE signal are therefore meant merely as exemplary of one advantageous application of the features and aspects hereof.

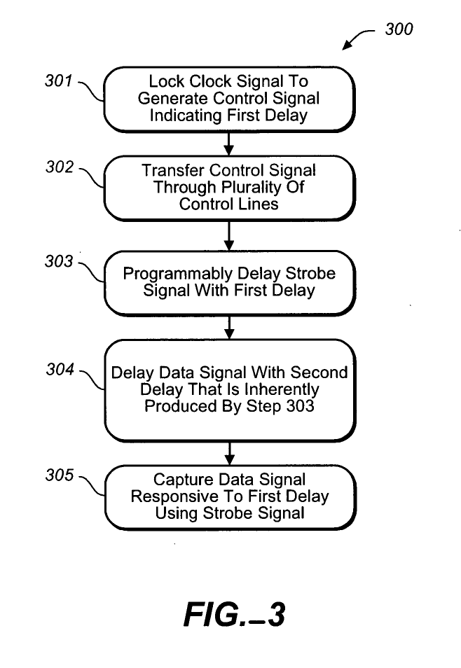

FIG. 3 illustrates a flowchart 300 of steps performed by a system for capturing data in one exemplary embodiment of the invention. In this embodiment, a master delay circuit, such as those described herein, locks onto a clock signal to generate a control signal that indicates a first delay, in step 301. The master delay circuit transfers the control signal through one or more control lines to one or more associated slave delay circuits, in step 302. The slave delay circuit may be similar to delay circuit 202 of FIG. 2. The control signal, accordingly, programs the slave delay circuits with the first delay such that the slave delay circuits delay incoming strobe signals by the first delay, in step 303. Step 303 may inherently produce an additive second delay associated with circuitry overhead. As such, an incoming data signal is delayed by a second delay to realign the data and the strobe signals in a manner similarly discussed in FIG. 2, in step 304. Once the data signal is realigned to the strobe signal with the second delay to achieve a desired, specified timing relationship, the data may be latched responsive to the first delay using the strobe signal, in step 305. Such a data latching may be performed by a logic circuit that registers the data signal with respect to substantially aligned strobe signal.

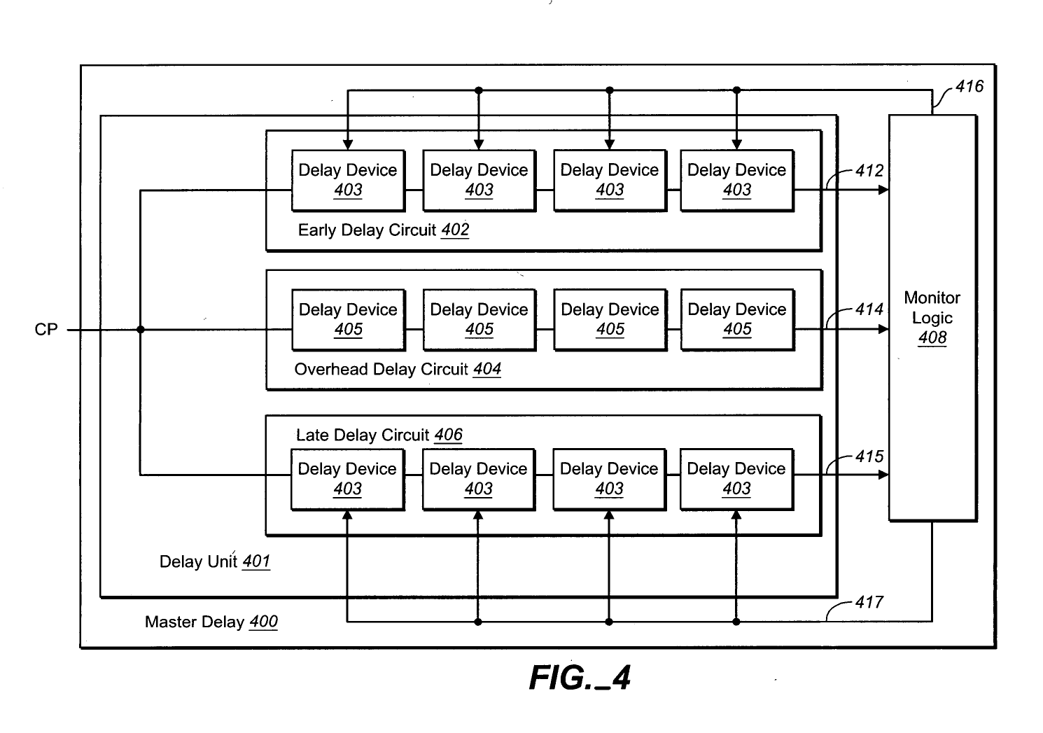

FIG. 4 illustrates a block diagram of master delay 400 in an exemplary embodiment of the invention. Master delay 400 may be suitable for use as master delay circuit 201 of FIG. 2. Master delay 400 includes delay unit 401 and monitor logic 408. Delay unit 401 is configured for receiving an input signal CP such as a clock signal from a high speed electronics device, and for generating early and/or late programmably delayed representatives of the input signal (i.e., 412 and 415, respectively). Monitor logic 408 is configured for detecting a phase difference between the input signal CP, and the early and/or late signals to provide a programmable delay to delay unit 401 that correspondingly adjusts the phase of signals 412 and 415. This adjustment of the phase may provide timing for master delay 400 that corresponds to the input signal CP. Master delays, as used for the purposes of timing, are known to those skilled in the art. Examples of typical master delays can be found at the following Micron Technology, Inc. website http://www.micron.com/content.jsp?path=/Publications/Product+Publications/DesignLine, and are herein incorporated by reference.

Delay unit 401 includes early delay circuit 402 for programmably delaying the input signal CP with a first delay to provide early signal 412. Delay unit 401 may also include late delay circuit 406 for programmably delaying the input signal CP with a second delay to provide late signal 415. The circuitry used to implement early delay circuit 402 and late delay circuit 406 typically has inherent overhead delays. Accordingly, in one embodiment of the invention, delay unit 401 may include delay circuit 404 for delaying the input signal CP with a delay that is substantially inherent to early delay circuit 402 and/or late delay circuit 406 to compensate the input signal CP with a similar overhead delay (illustrated as delayed input signal 414). This delay circuit 404 delay may align the input signal CP with early signal 412 and/or late signal 415 in terms of overhead delays imposed on those signals by respective circuits 402 and 406. Such an alignment may improve timing of master delay 400 because early signal 412 and/or late signal 415 are latched in monitor logic 408 with substantially all inherent delays accounted for.

In one particular embodiment of the invention, early delay circuit 402 and late delay circuit 406 include one or more delay devices 403 with circuit 402 having the same number of delay devices 403 as circuit 406. Delay devices 403 are configured for receiving programmable delay information from monitor logic 408 via feedback signals 416 and 417. Delay devices 403, as part of early delay circuit 402 and late delay circuit 406, are also configured for providing early signal 412 and late signal 415. To account for the overhead delays associated with the circuitry of delay device 403, overhead delay circuit 404 may include a number of delay devices 405 that corresponds to the number of delay devices 403 in either early delay circuit 402 or late delay circuit 406. Delay devices 405 may include essentially the same circuitry of delay devices 403 and may, therefore, account for overhead delays imposed on signals 412 and/or 415 by devices 403 by imposing a similar overhead delay on input signal CP (illustrated as delayed input signal 414).

While this embodiment illustrates a particular delay associated with programmable delay circuitry, other delays may be added to further compensate for delays associated with other circuitry within the master delay 400. Hence, it is not intended that the invention be limited to the type or number of delays in the exemplary embodiment of master delay 400.

Advantages of the above discussed embodiments include an improved accuracy in timing alignments between signals of a master/slave delay system, including timing alignments between data and strobe signals and timing alignments between clock and delayed clock signals. Accordingly, these advantages allow for a greater range of delay periods including fractions of clock periods to be accurately programmed using master/slave clock signal generation techniques. In addition, these advantages may lead to improved data registering in high speed electronic devices that use such and/or similar signals, thereby diminishing the potential for data corruption. Additionally, these advantages may lead to improved registering speeds as sub clock period delays dictated by a master delay circuit can be substantially accounted for. Other circuit delays may similarly fall within the scope of the invention

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A system, comprising:
a first delay circuit configured for programmably delaying a strobe signal with a first delay to latch a data signal; and
a second delay circuit configured for delaying the data signal with a second delay that is substantially inherent to the first delay circuit.

2. The system of claim 1, further comprising a logic circuit communicatively coupled between the first and the second delay circuits and configured for latching the data signal substantially aligned with the strobe signal.

3. The system of claim 2, wherein the logic circuit comprises a flip/flop device.

4. The system of claim 1, further comprising a master delay circuit configured for locking a clock signal and for programming the first delay circuit with the first delay therefrom.

5. The system of claim 4, wherein the second delay comprises a duration that is less than a cycle duration of the clock signal.

6. The system of claim 1, further comprising a plurality of the first and the second delay circuits.

7. The system of claim 1, wherein the first and the second delay circuits comprise substantially the same integrated circuitry such that the first delay circuit comprises a first overhead substantially having the second delay and the second delay circuit comprises a second overhead having the second delay.

8. A method of latching a data signal, comprising steps of:
programmably delaying a strobe signal with a first delay;
delaying the data signal with a second delay that is inherently produced by the step of programmably delaying; and
registering the data signal responsive to the first delay using the strobe signal.

9. The method of claim 8, further comprising a step of locking a clock signal to generate a control signal that programmably delays the strobe signal with the first delay.

10. The method of claim 9, wherein the step of locking comprises a step of simultaneously transferring the control signal through a plurality of control lines to uniformly perform the step of programmably delaying.

11. The method of claim 8, wherein the step of delaying the data signal comprises a step of generating the second delay such that the duration of the second delay is less than a cycle duration of the clock signal.

12. The method of claim 8, wherein the step of registering the data signal comprises steps of:
receiving the data signal; and
latching the data signal with the strobe signal.

13. A system for latching a data signal, comprising:
means for programmably delaying a strobe signal with a first delay;
means for delaying the data signal with a second delay that is inherently produced by the means for programmably delaying; and
means for registering the data signal responsive to the first delay using the strobe signal.

14. The system of claim 13, further comprising means for locking a clock signal to generate a control signal that programmably delays the strobe signal with the first delay.

15. The system of claim 14, wherein the means for locking comprises means for simultaneously transferring the control signal through a plurality of control lines to uniformly perform the means for programmably delaying.

16. The system of claim 13, wherein the means for delaying the data signal comprises means for generating the second delay such that the duration of the second delay is less than a cycle duration of the clock signal.

17. The system of claim 13, wherein the means for registering the data signal comprises:
means for receiving the data signal; and
means for latching the data signal with the strobe signal.

18. A system, comprising:
a first delay circuit configured for programmably delaying a first signal with a first delay to provide a delayed first signal; and
a second delay circuit configured for delaying the first signal with a second delay that is substantially inherent to the first delay circuit to latch the delayed first signal

19. The system of claim 18, further comprising monitor logic communicatively coupled between the first and the second delay circuits and configured for latching the delayed first signal in substantially alignment with the first signal.

20. The system of claim 19, wherein the monitor logic is further adapted to provide timing for the system that corresponds with the first signal and to program the first delay circuit with the first delay therefrom.

21. The system of claim 18, wherein the second delay comprises a duration that is less than a cycle duration of the first signal.

22. The system of claim 18, further comprising a plurality of the first and the second delay circuits.

23. The system of claim 18, wherein the first and the second delay circuits comprise substantially the same integrated circuitry such that the first delay circuit comprises a first overhead delay substantially having the second delay and the second delay circuit comprises a second overhead delay having the second delay.
